(19) United States
(12) Patent Application Publication
(10) Pub. No.: US 2015/0317898 A1
(43) Pub. Date: Nov. 5, 2015

(54) CELL PHONE KEY FOB ALERT SYSTEM

(71) Applicant: Gary Marsh, Salinas, CA (US)

(72) Inventor: Gary Marsh, Salinas, CA (US)

(21) Appl. No.: 14/265,449

(22) Filed: Apr. 30, 2014

(51) Int. Cl. G08B 21/24; G08B 25/10

(52) U.S. Cl. CPC G08B 21/24; G08B 25/10

(57) ABSTRACT

The cell phone key fob system comprises a cell phone key fob device and, in some embodiments, a mobile software application to be loaded on the mobile electronics device sought to be protected. The key fob device comprises a base key fob body having a activation switch, a speaker, a lanyard, an lanyard aperture in the fob body, and four indicator lights. The key fob device additionally includes an internal microcontroller, battery, Bluetooth transceiver and vibrating mechanism. When initially activated, the cell phone key fob device automatically bonds with the closest mobile communications device through a wireless connection. Subsequently, whenever the cell phone key fob device is turned on, it establishes a Bluetooth connection with the previously bonded cell phone through the transceiver. The connection is then monitored and, if lost, the speaker, lights, and vibrating mechanism activated to demonstrate an alarm condition to the user.

### BACKGROUND OF THE INVENTION

1. Field of the Invention

This invention relates generally to electronics accessories and, more particularly, to a cell phone key fob system which alerts a user whenever it is separated from a paired cell phone.

2. Description of the Prior Art

The use of personal mobile electronic devices, such as mobile phones, cameras, or mobile computers is very common in many modern societies. A problem which still exists, however, is that such due to their mobile nature devices are inherently prone to being misplaced or left behind by a user. Compounding this problem is that fact that often times, the user does not realize the device is missing until it is too late to conveniently retrieve it. Thus, there remains a need for a cell phone key fob system which would alert a user if a paired mobile electronic device became left a user's immediate vicinity. It would be helpful if such a cell phone key fob system was able to be wirelessly paired with a mobile electronic device. It would be additionally desirable for such a cell phone key fob system to alert a user of a missing mobile electronic device through notifications on the cell phone key fob system and on the paired mobile electronic device.

The Applicant's invention described herein provides for a key fob device adapted to be paired with a mobile electronic device and alert the user if the paired device leaves a certain physical proximity from the key fob device. The primary components in Applicant's cell phone key fob system are a key fob device having Bluetooth communications antenna and a software application loaded on the mobile electronic device to be paired with the cell phone key fob. When in operation, the cell phone key fob device uses visual, audible, and vibration stimuli to alert a user if a paired mobile device is about to be misplaced or left behind, while also causing an alarm to go off on the mobile device. As a result, many of the limitations imposed by prior art structures are removed.

### SUMMARY OF THE INVENTION

A cell phone key fob system for alerting a user when a mobile electronic device has been misplaced, left behind or otherwise leaves the user's vicinity. The cell phone key fob system comprises a cell phone key fob device and, in some embodiments, a mobile software application to be loaded on the mobile electronics device sought to be protected. The cell phone key fob device comprises a base key fob body having a activation switch, a speaker, a lanyard, an lanyard aperture in the fob body, and four indicator lights. The key fob device additionally includes an internal microcontroller, battery, Bluetooth transceiver and vibrating mechanism.

Prior to use, the cell phone key fob device must be bonded with a mobile communications device sought to be protected. When initially turned on, the cell phone key fob device automatically bonds with the closest mobile communications device through a wireless connection established by the transceiver. Subsequently, whenever the cell phone key fob device is turned, it seeks to establish a Bluetooth connection with the previously bonded cell phone through the transceiver. The connection is then monitored and, if lost, the speaker, lights, and vibrating mechanism activated to demonstrate an alarm condition to the user. In embodiments wherein the software application is employed, the alarm(s) present on the mobile communications device additionally go off when the connection with the cell phone key fob device is lost.

It is an object of this invention to provide a cell phone key fob system which would alert a user if a paired mobile electronic device became left a user's immediate vicinity.

It is another object of this invention to provide a cell phone key fob system capable of being wirelessly paired with a mobile electronic device.

It is yet another object of this invention to provide a cell phone key fob system which alerts a user of a missing mobile electronic device through notifications on the cell phone key fob system and on the paired mobile electronic device.

These and other objects will be apparent to one of skill in the art.

### BRIEF DESCRIPTION OF THE DRAWINGS

FIG. 1 is a top plan view of a cell phone key fob device of a cell phone key fob system built in accordance with the present invention.

FIG. 2 is shows the process flow of the mobile software application of a cell phone key fob system built in accordance with the present invention.

### DETAILED DESCRIPTION OF THE INVENTION

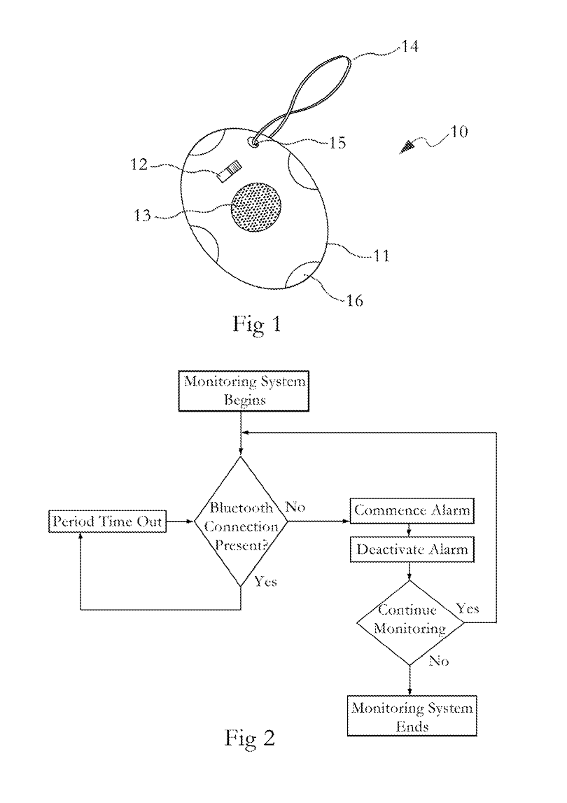

Referring now to the drawings and in particular FIG. 1, a cell phone key fob device 10 of a cell phone key fob system is shown as a base key fob body 11 having a activation switch 12, a speaker 13, a lanyard 14, an lanyard aperture 15 in the fob body 11, and four indicator lights 16. The activator switch 12 enables the cell phone key fob device 10 to be turned on and off by a user. The speaker 13 enables the cell phone key fob device 10 to emit an audible alarm to generate a audible stimuli to alert a user of an alarm condition. The lanyard 14 and lanyard aperture 15 enable the fob body to be attached to a user's person to prevent it from becoming lost. The lights 16 enable the cell phone key fob device 10 to generate a visible stimuli to alert a user of an alarm condition.

The key fob device additionally includes an internal microcontroller, battery, Bluetooth transceiver and vibrating mechanism. The microcontroller is connected to the battery, transceiver, switch 12, speaker 13, and lights 16 sufficient to allow the microcontroller to control the operation of the connected components and transmit and receive data through the transceiver. The battery is connected to the microcontroller, transceiver, switch 12, speaker 13, and lights 16 sufficient to supply electrical power to the components and enable their customary operation. The vibrating mechanism enables the cell phone key fob device 10 to generate a motion based stimuli to alert a user of an alarm condition.

Prior to use, the cell phone key fob device 10 must be bonded with a mobile communications device, such as a cell phone (not shown), sought to be protected. When initially turned on, the microcontroller is programmed to bond the cell phone key fob device 10 with a desired cell phone through a wireless connection established by the transceiver. Subsequently, when the cell phone key fob device 10 is turned on through the activation switch, the microcontroller is establishing a Bluetooth connection with the previously bonded cell phone through the transceiver. The microcontroller then monitors the Bluetooth connection with the cell phone. If the connection is lost, which it would be understood to be lost if the cell phone is no longer in range of the cell phone key fob device 10 for the Bluetooth signal, the microcontroller causes the speaker 13 to emit a audible alarm, the lights 16 to flash as a visible alarm, and the vibrating mechanism to cause the cell phone key fob device 10 to vibrate. In this regard, once the cell phone leaves the vicinity of the cell phone key fob device 10 the cell phone key fob device 10 generates a audible, visible, and motion based alarm.

Referring now to FIG. 2, a software program may also be loaded onto a cell phone to be bonded with the cell phone key fob device to enable the cell phone to also create a sensory alarm when the cell phone key fob device and the cell phone are out of Bluetooth range from one another. When the software application is installed, once the monitoring system begins and the Bluetooth connection is established between the cell phone having the software application and the cell phone key fob device, the software application monitors the Bluetooth connection status through the cell phone's transceiver. As long as the connection remains, the software application will simply continue to recheck the connection after a set period elapses form the previous check. If a check reveals the connection is lost, the software application causes an alarm to be generated by the cell phone. The alarm generated can be of any type available on the phone, such as audible, vibration, or visual. This alarm can be deactivated through the software application user interface on the cell phone. Once deactivated, a user can through said this interface either continue to monitor of end monitoring. It is understood, however, that if a user continues to monitor and the cell phone key fob device 10 has not been placed back in range of the cell phone, the alarm will re-commence.

It is contemplated that the software application may not be employed in all embodiments of the instant invention. In embodiments wherein the is employed, however, it may be utilized to enhance the bonding process.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A cell phone key fob system, comprising:
a cell phone key fob device defined by a key fob body containing a microcontroller connected to a battery, wireless transceiver, and vibrating mechanism and having an integrated speaker and at least one integrated light;
wherein said microcontroller is configured to establish a wireless network connection with an external electronic device through said transceiver and cause the vibrating mechanism to vibrate, speaker to emit an alarm sound, and light to flash light when external electronic device becomes outside of a predetermined proximity from said cell phone key fob.

2. The cell phone key fob system of claim 1, wherein said microcontroller is configured to bond with said external electronic device, enabling the microcontroller to authenticate the identity of the external electronic device prior to establish a wireless network connection therewith.

3. The cell phone key fob system of claim 2, wherein said wireless transceiver is a Bluetooth transceiver and the wireless network connection is a Bluetooth connection.

4. The cell phone key fob system of claim 1, wherein the microcontroller is configured to cause the vibrating mechanism to vibrate, speaker to emit an alarm sound, and light to flash light when wireless network connection with the external electronic device is lost due to becoming out of range.

5. The cell phone key fob system of claim 1, wherein the key fob body additionally has a lanyard aperture disposed thereon.

6. The cell phone key fob system of claim 1, wherein the key fob body includes four integrated lights.

7. The cell phone key fob system of claim 1, wherein said external electronic device is a mobile phone.

8. A cell phone key fob system, comprising:
a cell phone key fob device defined by a key fob body containing a microcontroller connected to a battery, wireless transceiver, and vibrating mechanism and having a lanyard aperture disposed thereon, an integrated activation switch, integrated speaker, and four integrated lights;
wherein said microcontroller is configured to establish a wireless network connection with an external electronic device through said transceiver and cause the vibrating mechanism to vibrate, speaker to emit an alarm sound, and lights to flash light when external electronic device becomes outside of a predetermined proximity from said cell phone key fob.

9. A cell phone key fob method, comprising the steps of:
providing a cell phone key fob device defined by a key fob body containing a microcontroller connected to a battery, wireless transceiver, and vibrating mechanism and having an integrated speaker and at least one integrated light;
establishing by said microcontroller a wireless network connection with an external electronic device through said transceiver;
monitoring by said microcontroller the wireless network connection with said external electronic device so as to enable a determination of whether the external electronic device is within a predetermined proximity relative to said cell phone key fob; and
causing by said microcontroller the vibrating mechanism to vibrate, speaker to emit an alarm sound, and light to flash light when external electronic device becomes outside of a predetermined proximity from said cell phone key fob. the wireless network connection.

10. The cell phone key fob method of claim 9, wherein said microcontroller is configured to bond with said external electronic device, enabling the microcontroller to authenticate the identity of the external electronic device prior to establish a wireless network connection therewith.

11. The cell phone key fob method of claim 10, wherein said wireless transceiver is a Bluetooth transceiver and the wireless network connection is a Bluetooth connection.

12. The cell phone key fob method of claim 9, wherein the microcontroller is configured to cause the vibrating mechanism to vibrate, speaker to emit an alarm sound, and light to flash light if the wireless network connection with the external electronic device is lost due to becoming out of range.

13. The cell phone key fob method of claim 9, wherein the key fob body additionally has a lanyard aperture disposed thereon.

14. The cell phone key fob method of claim 9, wherein the key fob body includes four integrated lights.

15. The cell phone key fob method of claim 9, wherein said external electronic device is a mobile phone.
